(19) United States
(12) Patent Application Publication
(10) Pub. No.: US 2024/0091792 A1
(43) Pub. Date: Mar. 21, 2024

(54) CENTRIFUGE

(71) Applicant: Eppendorf Himac Technologies Co., Ltd., Ibaraki (JP)

(72) Inventors: Kazunori MIYAMOTO, Ibaraki (JP); Ryo MURAYAMA, Ibaraki (JP)

(73) Assignee: Eppendorf Himac Technologies Co., Ltd., Ibaraki (JP)

(21) Appl. No.: 18/272,799

(22) PCT Filed: Nov. 10, 2021
(86) PCT No.: PCT/JP2021/041411

§ 371 Date: Jul. 18, 2023

(30) Foreign Application Priority Data
Feb. 24, 2021 (JP) 2021-026944

(51) Int. Cl. B04B 15/02; B04B 13/00

(52) U.S. Cl. CPC B04B 15/02; B04B 13/00

(57) ABSTRACT

A display screen 100 of an operation panel displays: a function (130) that gives notification of the performance of a periodic inspection of a cooling system; and an operation button 131 for starting inspection of the cooling system. During an easy inspection, a compressor 9a of the cooling system 9 is activated when a rotor 5 is not installed, it is determined whether the temperature detected by a temperature sensor 12 falls to a prescribed temperature (e.g., −3° C.) within a prescribed period of time (e.g., within 10 minutes) from activation, and the cooling system is determined to be normal if the detected temperature falls to the prescribed temperature and abnormal if not. The results of the determination are stored at a storage unit of the centrifuge, the timing 132 of the next inspection is displayed on the display screen 100, and it is possible to reference a past inspection history.

### TECHNICAL FIELD

The invention relates to a centrifuge having an easy inspection function of a cooling system.

### RELATED ART

A centrifuge (centrifugal separator) is an apparatus that inserts a sample to be separated (e.g., culture fluid, blood, etc.) into a rotor through a tube or a bottle, and applies a centrifugal force to the sample by rotating the rotor0 at a high speed, thereby separating substances of different densities. The centrifuge has a bowl defining a rotation chamber that is a space in which the rotor rotates at a high speed. The opening part of the bowl is closed by an openable door. The rotor holding the sample is rotated at a high speed for centrifugation by using a driving device such as a motor, thereby separating, purifying, etc., the sample. Here, when the rotor is rotated at a high speed in the air, due to the frictional heat (windage loss) generated between the outer surface of the rotor and the air in the rotation chamber, the temperature rises. Since the sample to be separated needs to be kept at a low temperature, most centrifuges are equipped with a cooling system. Although a Peltier element may be adopted as a cooling system, a compressor type having a cooling system formed by an evaporator, a compressor, a condenser is widely used. In the compressor type cooling system, a copper pipe is wound on the outer side of the outer peripheral wall of the bowl, and a refrigerant flows in the copper pipe, thereby cooling the interior of the rotation chamber and cooling the rotor.

In the case of a centrifuge in which a cooling system using Freon as refrigerant is mounted, the refrigerant may leak to the outside (refrigerant leaks) due to leaks from a pipe or other reasons. It is important to find the state of refrigerant leakage at an early stage, and it is important to prevent further refrigerant leakage. In addition, it is necessary to avoid a centrifugal separation operation as much as possible in the state in which the refrigerant leaks out. In the case where a defect of the cooling system is found out after the centrifugal separation operation has started, the sample may even be lost. Therefore, it is recommended to frequently inspect the cooling system. In addition, due to restrictions imposed by laws, standards bodies, etc., there are many cases where inspections of the cooling system are required at regular intervals.

As a means for detecting an abnormality of a cooling system, Patent Document 1 is configured to be provided with temperature sensors attached to an inlet side and a discharge side of an evaporator, and when a temperature difference of a specific temperature or higher occurs between the temperature sensors, a control means determines that the refrigerant is leaking, and the user is notified of the refrigerant leakage. In addition, in Patent Document 2, temperature sensors are attached to the cooling system, and refrigerant leakage is predicted by measuring the temperatures of the respective parts to be used as the inspection of the cooling system. In Patent Documents 1 and 2, two or more temperature sensors for cooling system inspection are used to determine refrigerant leakage from the detected temperatures.

### CITATION LIST

### Patent Literature

Patent Document 1: Japanese Laid-open No. 2005-90953
Patent Document 2: Japanese Patent No. H11-211292

### SUMMARY OF INVENTION

### Technical Problem

In the abnormality detection of the cooling system using the technique of Patent Document 1 or Patent Document 2, multiple temperature sensors are required, which leads to a higher manufacturing cost of the centrifuge, making it difficult to adopt such technique. In addition, neither of the techniques discloses a method for the user to inspect the cooling system prior to use.

The invention has been made in view of the above background, and an objective of the invention is to provide a centrifuge provided with a function of detecting an abnormality of a cooling system by using a user-friendly method, while suppressing the manufacturing cost. Another objective of the invention is to provide a centrifuge allowing the user to easily execute an inspection on a cooling system before a centrifugal separation operation starts. Yet another objective of the invention is to provide a centrifuge provided with a notification function that urges the user to execute periodic inspections and able to easily manage inspection results.

### Solution to Problem

The typical characteristics of the invention disclosed in the present application are as follows.

According to a characteristic of the invention, a centrifuge includes: a driving device; a bowl, accommodating a rotor rotating by using the driving device; a sensor, detecting a temperature inside the bowl; a cooling device (cooling system) for cooling an interior of the bowl; a display part, inputting a centrifugal separation operation condition and displaying an operation state; and a control part, controlling the display part. The centrifuge is provided with an easy inspection mode for detecting an abnormality of the cooling device. When the easy inspection mode is selected, the control part determines whether the cooling device is abnormal while operating a motor of a compressor provided in the cooling device at a speed determined in advance. The easy inspection mode is executed in a state in which the rotor is not installed or in a state in which the rotor that is installed is not rotated. The determination on whether the cooling device is abnormal is made by determining whether a temperature drops from a predetermined temperature to a prescribed temperature within a predetermined time period. A determination result is displayed on the display part. The control part stores in advance a normal range of temperature change after the cooling device (cooling system) is started, and easily determines that the cooling device is “abnormal” in the case where the temperature change at the time of executing the simple inspection is out of the normal change and “normal” in the case where the temperature change at the time of executing the simple inspection falls within the normal change.

According to another characteristic of the invention, after execution of the easy inspection mode, the control part stores the required time and a temperature reached within the predetermined time period, together with date data indicating an inspection date, in a non-volatile storage part. In addition, when power of the centrifuge is activated, the control part compares a current date and time with the next inspection execution date. If a number of days until the next inspection execution date is less than a predetermined number of days, an alert is displayed on the display part. In addition, the control part displays an overview of execution results of inspection modes stored in the storage part on the display part. In the case of determining that the cooling device is “abnormal” according to the execution result of the easy inspection mode, the control part may prohibit or limit an operation of the centrifuge

### Effects of Invention

According to the invention, an easy inspection on the cooling system can be executed with a cheap and simple operation by using the conventional temperature sensor to change (rewrite) the software of the control part. In addition, since no new hardware apparatus is added for implementing the invention, the increase in manufacturing cost can be suppressed. In addition, since an easy inspection on the cooling system can be executed before the centrifugal separation operation starts, the performance deterioration or failure of the cooling system can be inspected beforehand. In addition, since the periodic inspection timing is shown to the user on the display screen of the centrifuge, the periodic inspection can be prevented from being omitted, and the user's load for managing the inspection timing can be alleviated. Moreover, after the inspection is executed, the inspection result is automatically stored in the storage device and managed by the control part. Therefore, the user can easily check previous inspection results.

### BRIEF DESCRIPTION OF DRAWINGS

FIG. 1 is a longitudinal cross-sectional view illustrating an overall configuration of a centrifuge 1 according to an embodiment of the invention.

FIG. 2 is a view illustrating an example of a display screen 100 displayed on an operation panel 10 of the centrifuge of FIG. 1.

FIG. 3 is a view illustrating a display screen 150 when a cooling system easy inspection of the embodiment is executed.

FIG. 4 is a first half of a flowchart illustrating a processing order of the cooling system easy inspection of the embodiment.

FIG. 5 is a flowchart following FIG. 4 and is a second half of the flowchart illustrating the processing order of the cooling system easy inspection.

FIG. 6 is a view illustrating a display screen 150A when a cooling system easy inspection of the embodiment is executed.

FIG. 7 is a view illustrating a display screen 150B when a cooling system easy inspection of the embodiment is executed.

FIG. 8 is a view illustrating a display screen 150C when a cooling system easy inspection of the embodiment is executed.

FIG. 9 is a view illustrating a display screen 100A after a cooling system easy inspection of the embodiment is executed.

FIG. 10 is a view illustrating a display screen 160 illustrating history contents of an easy inspection stored in a storage part.

### DESCRIPTION OF EMBODIMENTS

### Embodiment 1

In the following, the embodiments of the invention will be described based on the drawings. In the following figures, parts having the same functions are denoted by the same reference numerals, and repeated description is omitted. Further, in this specification, the front-rear and upper-lower directions are described as the directions shown in the drawings.

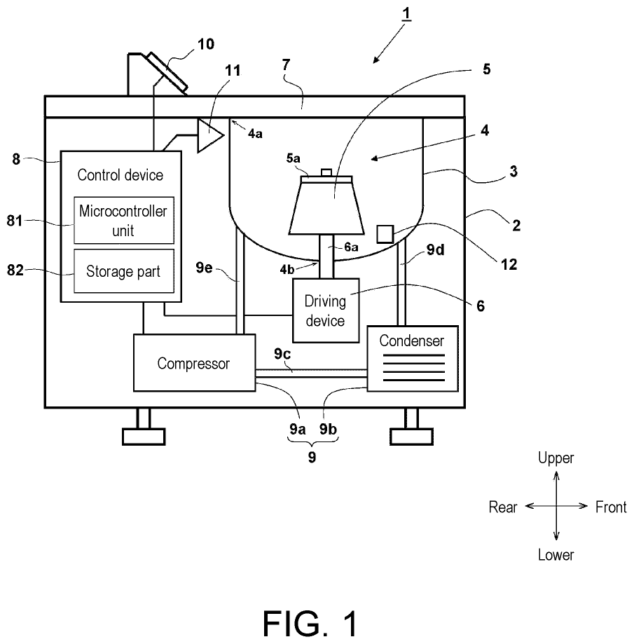

FIG. 1 is a schematic longitudinal cross-sectional view illustrating an overall configuration of a centrifuge 1 according to an embodiment of the invention. The centrifuge 1 is provided with a metal bowl 3 inside a housing 2 formed by box-shaped sheet metal or the like. When viewed from the upper side of the rotation shaft, the bowl 3 is in a cup shape having a circular or substantially circular outer shape, and an opening part 4a having a circular opening shape is formed on the upper side. The opening part 4a is closed by a door 7 in an arbitrary shape. Here, the opening part a is closed by the door 7 of a single door type that can be opened or closed by swinging with a hinge (not shown), and a rotation chamber 4 as a space in which the rotor 5 rotates is formed by the bowl 3 and the door 7.

The rotor 5 is installed to the upper end of a rotation shaft 6a of a driving device 6, such as a motor. A cover 5a is provided at the upper part of the rotor 5. Regarding the driving device 6, an AC motor driven by using a commercial AC power source or a brushless motor controlled by an inverter is used. On the lower side of the bowl 3, the rotation shaft 6a is disposed in the upper-lower direction (vertical direction) penetrating through a through hole 4b of the bowl 3. The rotor 5 accommodates a sample container that holds a sample to be separated, and is a so-called angle rotor. In the embodiment, the type of the rotor 5 is arbitrary, whether the cover 5a is provided is arbitrary, and, instead of the angle rotor, a swing rotor or rotors of other shapes may also be adopted. In addition, the shape, quantity, and capacity of the sample container accommodated inside the rotor 5 are arbitrary.

On a side of the door 7, an operation panel 10 is disposed. The operation panel 10 allows the user to input a set condition, such as the rotation speed of the rotor, the separation time, etc., and displays various information. The operation panel 10 functions as a display part visually indicating the state of the centrifuge to the user and functions as an input part for the user to input control information as necessary for the operation of the centrifuge. In the embodiment, the operation panel is formed by a touch panel-type liquid crystal display. In the invention, the shape of the operation panel 10 is arbitrary, and may also be formed by a dot matrix display device, instead of a liquid crystal device, and a conventional input device, such as multiple switches. A control device (control part) 8 controls the entire centrifuge 1, and is formed by including a microcontroller unit 81 and a storage part 82 formed by a volatile memory. In addition, the control device 8 executes control on the entire centrifuge 1, such as the rotation control of the driving device 6, the operation control of the cooling system 9, the temperature management in the rotation chamber 4, the display control on the operation panel 10, the input control of the operation of the operation panel 10, in accordance with various information for the centrifugal separation operation input from the operation panel 10.

The rotation chamber 4 is cooled off to a set temperature by using the cooling system 9. A sample temperature inside the rotor 5 is measured by a temperature sensor 12 disposed in the rotation chamber 4. In the embodiment, the temperature sensor 12 is provided at the bottom part of the bowl 3. The temperature sensor 12 is a measurement apparatus that indirectly estimates the temperature of the rotor 5 by measuring the inner side temperature or the surface temperature of the bowl 3. The output of the temperature sensor 12 is transmitted to the control device 8 through a signal line not shown herein. If a door opening/closing detection sensor 11 determines the door 7 is closed, the control device 8 operates the cooling system 9 so that the sample temperature inside the rotor 5 is kept at the set temperature input by the user. In the control device 8, the output of the temperature sensor 12 is monitored by the microcontroller unit 81, and feedback control is executed so that the cooling system 9 is operated in the case where the temperature of the rotation chamber 4 is higher than the set temperature, and the operation of the cooling system 9 is weakened or stopped in the case where the temperature of the rotation chamber 4 is lower than the set temperature.

The bowl 3 is formed by a metal alloy, such as stainless steel, and the outer peripheral surface thereof is spirally wound by a copper pipe. On the outer side of the copper pipe that is wound, a conventional heat insulation material not shown herein is provided, and is configured to prevent the heat of the bowl from leaking to the outside. The copper pipe forms a portion of the cooling system 9. A refrigerant is transmitted from a compressor 9a included in the cooling system 9 to a condenser 9b through a copper pipe 9c. By using the condenser 9b and a fan (not shown), the cooled refrigerant is liquefied. The liquefied refrigerant is supplied to a copper pipe 9d after passing through a capillary (not shown) and arrives at an inlet of a winding part (an evaporator part) of the outer periphery of the bowl 3. At the winding part (not shown) on the outer periphery of the bowl 3, the refrigerant cools off the interior of the rotation chamber 4 by rapidly taking away the heat of the surface of the bowl 3. The refrigerant that takes away the heat of the bowl 3 and is vaporized returns to the compressor 9a from the outlet of the winding part of the copper pipe through a copper pipe 9e. In this way, the inside of the rotation chamber 4 is constantly kept at the desired temperature set through the control exerted on the cooling system 9 by the control device 8. As an example of the control on the cooling system 9, temperature control is executed by activating or deactivating the rotation of a compressor motor (not shown) that drives the compressor 9a, and the temperature control is executed by the control device 8.

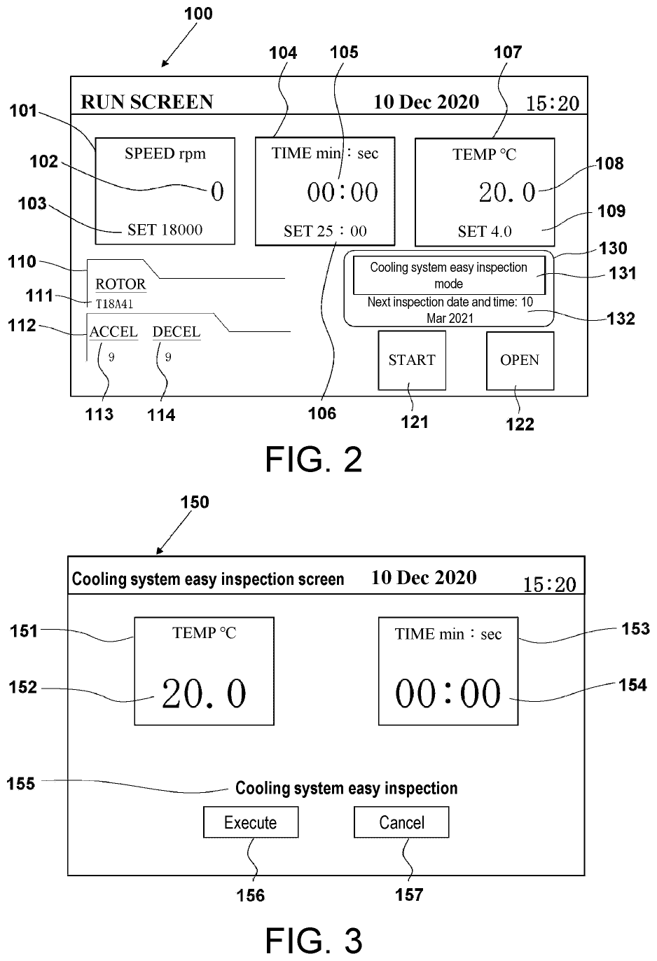

FIG. 2 is a view illustrating an example of a display screen 100 displayed on the operation panel 10 of the centrifuge of FIG. 1. In the embodiment, an example in which the operation panel 10 (see FIG. 1) is implemented by using a touch panel type liquid crystal display is described. The display screen 100 is a basic screen for displaying the control information and the operation state relating to the centrifugal separation operation. The upper portion (upper side portion) in the screen is assigned three display fields, which are a rotor rotation speed display field 101, an operation time display field 104, and a rotor temperature display field 107. The rotor rotation speed display field 101 is a region for displaying the rotation speed (rotation/minute) of the rotor 5. A current rotor rotation speed 102 actually measured by a rotation sensor (not shown) is displayed in a large size on the upper side, and a set rotation speed 103 set by the user is displayed in a small size on the lower side. The rotation time display field 104 is a region displaying the operation time of centrifugal separation. An elapsed time 105 from the time when the rotor is in a settling state to the present time is displayed in a large size, and a set (operation) time 106 input by the user is displayed in a small size on the lower side. The rotor temperature display field 107 is a region displaying the temperature of the rotor 5 (or the internal temperature of the rotation chamber 4). A current rotor temperature 108 measured by the temperature sensor 12 is displayed in a large size at the upper part, and a set temperature 109 input by the user is displayed in a small size at the lower part.

When the user touches one of the rotor rotation speed display field 101, the operation time display field 104, and the rotor temperature display field 107, a pop-up screen indicating a ten-key input screen (not shown) is displayed, and with the user inputting a set value from the ten-key input screen and pressing an enter key (not shown), the screen returns to the display screen 100 in a state in which the numerical value that is set is input to the display field (one of 101, 104, and 107).

In a rotor name display region 110, an identification symbol corresponding to the type of the rotor 5 in use is displayed. Here, the type name “T18A41” of the rotor 5 is displayed. With the user touching the rotor name display region 110, an overview of the identification symbols of selectable rotors 5 is displayed through a pop-up screen, and, with the user choosing one of the identification symbols, the identification symbol of the rotor 5 is displayed in a rotor name 111 of the rotor name display region 110. Alternatively, it may also be that the identifier provided in the rotor is determined by the control device 8 and automatically displayed in the rotor name 111.

In an acceleration/deceleration mode display region 112, an acceleration gradient (ACCEL) 113 of the rotation from the stopped state until the rotor 5 reaches the set rotation speed when the operation starts and a deceleration gradient (DECEL) 114 of the rotation from the set rotation speed until the rotation 5 reaches the stopped state when the operation stops are respectively displayed in association with numerical levels. Regarding the setting, with the user touching the acceleration/deceleration mode display region 112, selectable acceleration gradients 113 and deceleration gradients 114 are respectively displayed through a pop-up screen and selected by the user.

On the lower right of the display screen 100, a start button 121 and an open button 122 are displayed. The start button 121 is an icon for starting a centrifugal separation operation under the operation condition set on the display screen 100. The open button 122 is an icon for instructing to unlock to open the door 7. When the user closes the door 7, the door is locked, and when the user touches the start button 121, the centrifugal separation operation starts. When the centrifugal separation operation starts, the control device 8 displays a stop button (not shown) in place of the open button 122.

When viewed in the upper-lower direction, a cooling system easy inspection mode field 130, which is the characteristic of the embodiment, is provided between the start button 121 and the rotor temperature display field 107. In the cooling system easy inspection mode field 130, an operation button 131, which is an icon for instructing the user to execute a specific operation, and an associated information 132 relating to execution of “cooling system easy inspection” with respect to the user are displayed. Here, in order to clarify the boundary between the cooling system easy inspection mode field 130 and other areas, the cooling system easy inspection mode field 130 is surrounded by a rounded rectangular frame with rounded corners. Although FIG. 3 is displayed as a black-and-white figure, a monochrome display or a color display may be adopted for the operation panel 10. In the case where a color display is used, the background in the cooling system easy inspection mode field 130 is colored to be easily distinguished from other display regions (101, 104, 107, etc.), or the color of the background color may be displayed differently in accordance with the importance of the contents of the associated information 132, thereby enhancing the distinguishability.

When the user touches the operation button 131, the control device 8 shifts to the screen of the next specific operation (the cooling system easy inspection shown in FIG. 3). On the lower side of the operation button 131, as a message to the user, the associated information 132 indicating “next inspection date: 10 Mar. 2021” is displayed. Although mainly displayed as text, the associated information 132 may also be displayed as an image. How the associated information 132 is displayed, the display form, the display color, the character size, etc., may be set arbitrarily. For example, during a period of three to two months before the next inspection date, the text may be displayed smaller than the text in FIG. 2, during a period of two to one month before the next inspection date, the text may be displayed as in FIG. 2, and during a period of less than one month, the text of the associated information 132 may be highlighted or displayed conspicuously in red, etc. In the case where the importance of the display of the associated information 132 is low, it may also be that nothing is displayed until the importance elevates.

In the embodiment, the scheduled date on which the next inspection is executed is displayed as the associated information 132. For example, if a specific law or regulation indicates that it is obligatory to execute periodic inspection (e.g., once every three months), the date that is three months from the date on which the inspection is previously executed is displayed as the scheduled date on which the next inspection is executed. The size of the display field of the cooling system easy inspection mode field 130 or the position thereof on the display screen 100 can be set arbitrarily in accordance with the size of the operation panel 10 or the arrangement of the respective display regions. For example, the display field of the associated information 132 may be added to two or three rows to increase the amount of information that can be displayed. In addition, it may also be that a space is secured between the outer frame upper line of the cooling system easy inspection mode field 130 and the upper side of the operation button 131 to provide a display field for the second associated information. In the case where the display field for the second associated information is provided, it is possible to display “previous inspection date: 20 Sep. 2020” as the previous inspection execution date, and such display allows the user to easily recognize the previous inspection execution date.

When the user touches the operation button 131 of the cooling system easy inspection, the screen switches to a cooling system easy inspection start screen 150 of FIG. 3. In the cooling system easy inspection start screen 150 shown in FIG. 3, at an upper end position, “cooling system easy inspection start screen” and the title of the screen are displayed in text, and the current date and time are displayed on the right. The cooling system easy inspection start screen 150 mainly displays two information display fields (151, 153) and two operation instruction icons (156, 157). Here, the “easy inspection” of the cooling system 9 in the embodiment refers to operating the cooling system 9 under a specific condition without changing the hardware configuration of the centrifuge 1, and determining whether the cooling system 9 is abnormal by using the control device 8 based on the information obtained from various sensors at that time. Accordingly, whether the cooling system 9 is abnormal can be determined by the single centrifuge without using (without preparation) of dedicated equipment, such as a leak tester, that detects whether the refrigerant leaks.

In the current temperature display field 151, a current temperature 152 of the rotation chamber 4 measured by the temperature sensor 12 is displayed. In the inspection time display field 153, an elapsed time 154 since the easy inspection mode is executed is displayed in the unit of minute:second. In FIG. 3, the state before the easy inspection mode starts is displayed, and the elapsed time 154 is displayed as “00:00”.

On the lower side of the two information display fields (151, 153), a message 155 to the user is displayed, and an execution button 156 and a cancel button 157 for inputting the user's instruction with respect to the message 155 are displayed in the form of icons. Here, when the user touches the execution button 156, the microcontroller unit 81 of the control device 8 starts executing the “cooling system easy inspection mode” of the centrifuge 1. At this time, it is not required that the rotor 5 (see FIG. 1) be set to the rotation shaft 6a (see FIG. 1). In addition, although the easy inspection mode of the cooling system can be executed even in the case where the rotor 5 is installed to the rotation shaft 6a, as it is not necessary to rotate the rotor 5, the rotation device 6 for the rotor 5 may be set to the stopped state at the time of executing the easy inspection (however, it is still possible to perform easy inspection while rotating the rotor 5). In FIG. 3, when the user touches the cancel button 157, the screen returns to the display screen 100 of FIG. 2, which is the initial screen, without starting the operation of the “cooling system easy inspection mode”.

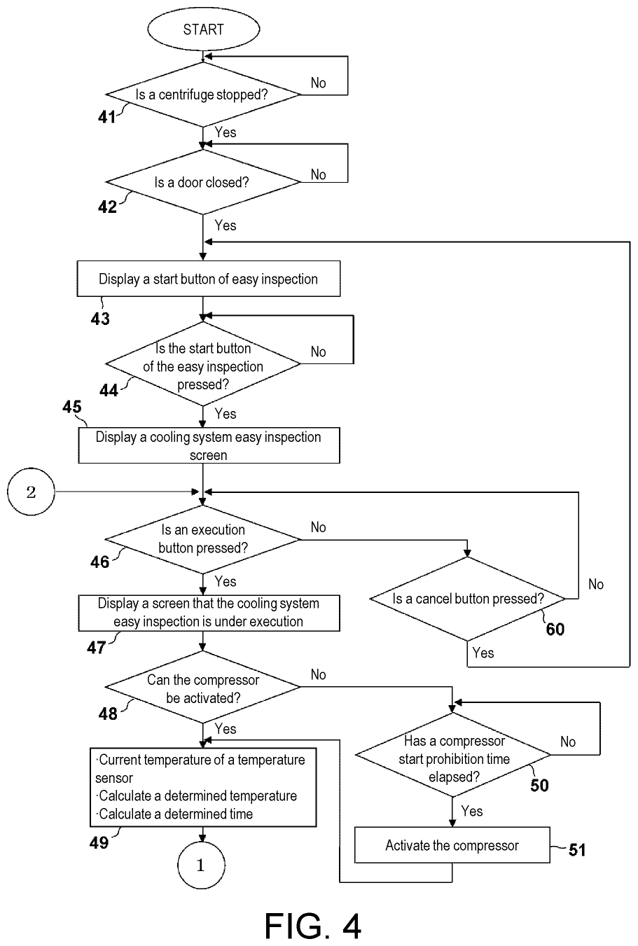

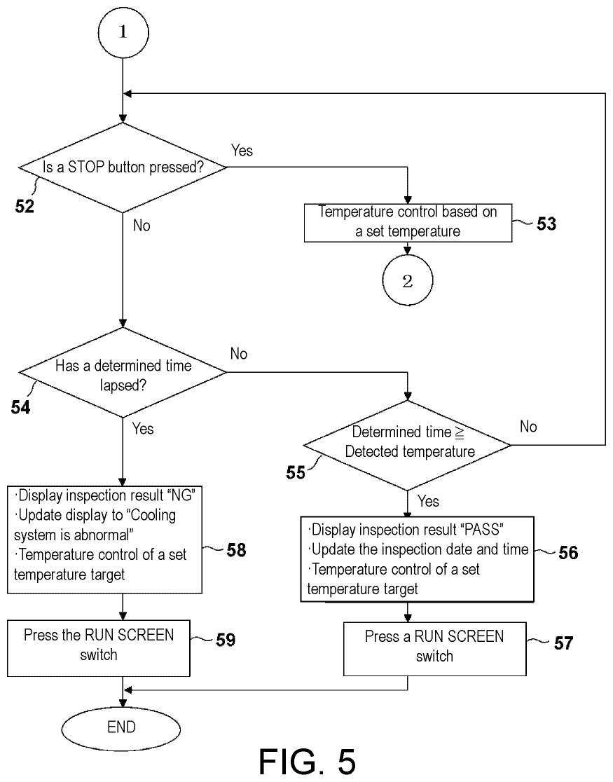

FIGS. 4 and 5 are flowcharts illustrating a processing order of the control part in the “cooling system easy inspection mode” of the centrifuge 1 of the embodiment. A series of procedures shown in FIGS. 4 and 5 are performed by executing, by the microcontroller unit 81, a program stored in advance in the storage part 82 of the control device 8. In addition, such program is executed in background in parallel with the main program performing the centrifugal separation operation, etc.

Firstly, the microcontroller unit 81 determines whether the rotation of the rotor 5 of the centrifuge 1 is stopped (Step 41). This is because, in the state in which the rotor 5 is rotating, that is, when the centrifugal separation operation is being executed, the cooling system easy inspection according to the embodiment cannot be executed. When the rotation of the rotor 5 of the centrifuge 1 is not stopped in Step 41, the microcontroller unit 81 stands by until the rotation stops. When the centrifuge 1 is stopped, next, the microcontroller unit 81 detects whether the door 7 is closed from the output of the door opening/closing detection sensor 11 (Step 42). Since the cooling system easy inspection cannot be executed when the door 7 is opened, the microcontroller unit 81 stands by until the door 7 is closed.

In the case where the door 7 is closed in Step 42, the microcontroller unit 81 displays, on the display screen 100, the operation button 131 of the cooling system easy inspection mode (Step 43). As shown in FIG. 2, the operation button 131 is displayed in the form of an icon in the cooling system easy inspection mode field 130, and the associated information 132 is also displayed at the same time. If the power of the centrifuge 1 is activated, the microcontroller unit 81 compares the current date and time with the next inspection execution date and displays the next inspection execution date in the cooling system easy inspection mode field 130. Alternatively, the next inspection execution date may not necessarily be displayed, but an alert may be displayed on the display part if the number of days until the next inspection execution date is less than a predetermined number of days.

Next, the microcontroller unit 81 determines whether the operation button 131 for instructing the start of the cooling system easy inspection is pressed (touched) (Step 44), and, if the operation button 131 is pressed, the microcontroller unit 81 switches the display of the operation panel 10 to the display screen 150 as shown in FIG. 3 (Step 45). In Step 44, in the case where the operation button 131 is not pressed (touched), the microcontroller unit 81 stands by until any of the buttons is pressed.

Next, the microcontroller unit 81 determines whether the execution button 156 is pressed (touched) in the display screen 150 displayed in Step 45 (Step 46). If the user presses the execution button 156 (see FIG. 3) in Step 46, the microcontroller unit 81 starts the cooling system easy inspection, and displays to the user on the operation panel 10 that the cooling system easy inspection is “under execution”. In the case where the execution button 156 is not pressed in Step 46, the microcontroller unit 81 determines whether the cancel button 157 is pressed (Step 60), stands by if the cancel button 157 is not pressed, and returns to Step 43 if the cancel button 157 (see FIG. 3) is pressed.

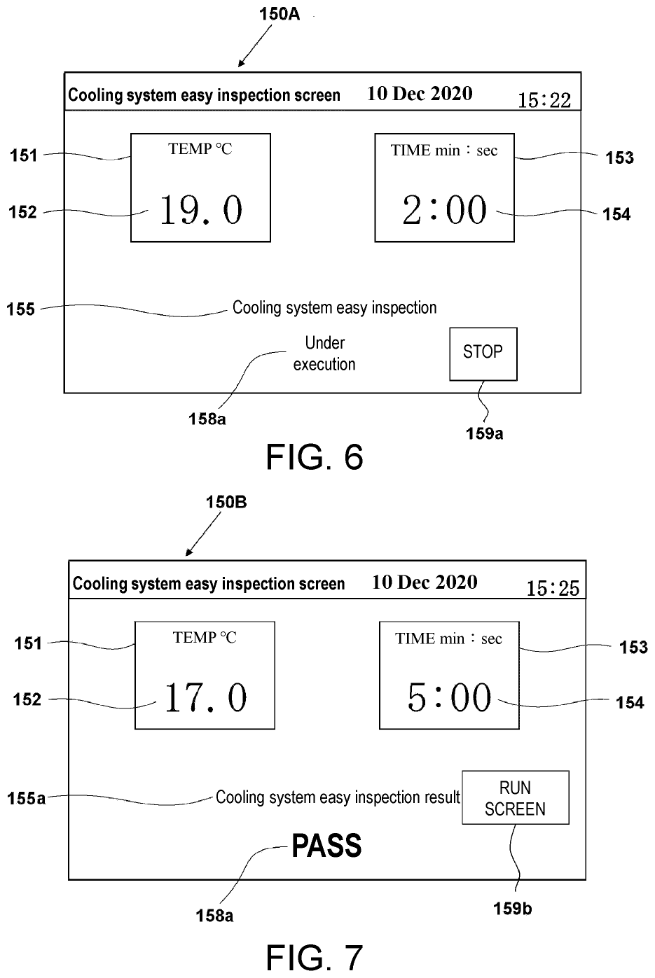

Then, a display screen 150A displayed in Step 47 of FIG. 4 is described with reference to FIG. 6. FIG. 6 is a transition screen from FIG. 3. Here, the display is switched from the execution button 156 of FIG. 3 to a status information 158a indicating “under execution”. In addition, the cancel button 157 of FIG. 3 is changed to a stop button 159a for interrupting the cooling system easy inspection under execution. By reading the message 155 and the following status information 158a, the user can recognize that the cooling system easy inspection is under execution. At this time, as the time passes, the time display of the elapsed time 154 is counted up. The start point of the elapsed time 154 is the time when the cooling system easy inspection is started, which here refers to the time when the operation of the cooling system of the inspection target is started, more specifically, the time when the operation of the compressor 9a starts.

Referring to FIG. 4 again, in Step 48, the microcontroller unit 81 determines whether the cooling system (including the compressor 9a and the condenser 9b herein) can be activated (Step 48). The reason is that, a pressure difference is generated between the suction side and the discharge side of the refrigerant of the compressor 9a immediately after the operation stops, the discharge side has a high pressure relative to the suction side, and if the compressor 9a starts operating from the state in which the compressor 9a is stopped while the discharge side is in the high-pressure state, a load greater than usual is applied to the motor driving the compressor part of the compressor 9a, and a starting failure may occur. In this way, the cooling system cannot be restarted unless the pressure of the discharge side drops to a certain level. Therefore, in the case of operating in advance, after the operation of the compressor 9a stops, the operation resumes after waiting for a predetermined time period (e.g., 2 minutes). If the compressor 9a is in the state of being able to activate in Step 48, the microcontroller unit 81 activates the compressor 9a and operates the motor of the compressor 9a at a speed determined in advance, reads the current temperature detected by the temperature sensor 12, and counts the elapsed time. In addition, the microcontroller unit 81 calculates a determined temperature and a determined time according to the detected temperature and the elapsed time (Step 49).

In the case where the compressor 9a is unable to activate immediately in Step 48, the microcontroller unit 81 stands by until the start prohibition time of the compressor 9a elapses (Step 50), activates the compressor 9a after the start prohibition time has elapsed, and proceeds to Step 49 (Step 51). Regarding the calculation of the determined temperature and the determined time, in the case where the detected temperature detected by the temperature sensor 12 at the time when the execution button 156 is pressed is 20° C., the determined temperature is set to 17° C. and the determined time of 10 minutes is calculated. In the case where the detected temperature detected by the temperature sensor 12 is 4° C., the determined temperature of 1° C. and the determined time of 5 minutes are calculated. As the calculation method, a predetermined calculation formula may be used, or a table stored in advance may be referred to for calculation.

In the easy inspection of the embodiment, the cooling system 9 is operated, and, based on whether the temperature drops by a reference drop temperature t (° C.) from a start point temperature T₀ (° C.) within a reference time M (minutes), whether an abnormality due to refrigerant leakage of the cooling system 9 or other factors occurs is determined. In addition, the temperature of one of the rotation chamber 4 and the bowl 3 detected by the temperature sensor 12 when the compressor 9a is activated is set as the start point temperature T₀, the reference drop temperature is set as t=3(° C.), and a required time m for reaching a drop temperature (T₀−3) (° C.) is measured. In addition, if m<M, it is simply determined that the cooling system 9 has no issue, and if m≥M, it is simply determined that an issue occurs in the cooling system 9 and it is necessary to perform a detailed inspection. To which extent the reference time M (minutes), which is the threshold for determination, should be set may be properly configured in accordance with the type or the properties of the compressor 9a in use. In the embodiment, M=10 (minutes).

In the flowchart of FIG. 5, during the execution of the cooling system easy inspection, the microcontroller unit 81 monitors whether the stop button 159a (see FIG. 6) is pressed (touched), and in the case where the stop button 159a is pressed, displays on the operation panel 10 “Are you sure you want to stop the easy inspection? Yes No” as the information prompting confirmation to stop the inspection. The portions “Yes” and “No” may also be displayed independently in the form of icons. Here, if the user selects “Yes” to confirm to stop the easy inspection, the temperature control operation so that the set temperature of the cooling operation of the cooling system 9 becomes the set temperature 109 set in FIG. 2 is maintained (Step 53), and the flow returns to Step 46 of FIG. 4. At this time, the display of the operation panel 10 returns to the contents of FIG. 2.

In the case where, in Step 52, the stop button 159a (see FIG. 6) is not pressed or NO for execution is selected in the confirmation through the message after the stop button 159a (see FIG. 6) is pressed, the microcontroller unit 81 determines whether the time counted up reaches the predetermined reference time M (10 minutes herein) in Step 54. When the reference time M has not elapsed, the microcontroller unit 81 determines whether the current temperature measured by the temperature sensor 12 drops to the determined temperature (=T₀−t) through the operation of the cooling system (Step 55). That is, in the cooling system easy inspection of the embodiment, whether the cooling system is abnormal is determined by whether the temperature t of the rotation chamber 4 drops by 3° C. within the reference time M=10 minutes. In the case where the temperature drop is not achieved in Step 55, the flow returns to Step 52 (Step 55).

If it can be confirmed that the temperature of the rotation chamber 4 or the bowl 3 detected by the temperature sensor 12 (see FIG. 1) drops by 3° C. within 10 minutes in Step 55, the microcontroller unit 81 displays the result of the easy inspection on the operation panel 10 (Step 56). Such display contents are as shown in a display screen 150B of FIG. 7.

The display screen 150B of FIG. 7 is a screen indicating that the easy inspection is completed and passed, that is, the cooling system is normal. In addition, the display screen 150B is a transition screen from the display screen 150A of FIG. 6. The upper half region of the display screen 150B has the same contents as FIG. 6, and it is displayed that the current temperature 152 measured by the temperature sensor 12 reaches the prescribed temperature (=17.0° C.) after dropping by the reference drop temperature t=3° C. from the start point temperature T₀=20° C. shown in FIG. 3. In addition, it is displayed that the time (elapsed time 154) required for the cooling system 9 to lower the temperature by the reference drop temperature t=3° C. is 5 minutes and 00 seconds. Since 3° C. of the reference drop temperature is achieved, the counting of the elapsed time 154 is stopped, and the elapsed time 154 remains to be 5 minutes and 00 seconds afterwards. A message 155a to the user displays the information indicating the easy inspection ends and showing the result. That is, the message 155a displays “cooling system easy inspection result”, and contents corresponding to the message 155a, which indicates “Pass” here as an easy inspection result 158a, is displayed on the lower side of the message 155a. On the right side of the message 155a, a RUN SCREEN button 159b, which is an icon for returning to the display screen 100 of FIG. 2, is displayed.

Referring to FIG. 5 again, in Step 56, the microcontroller unit 81 stores the execution date of the easy inspection, the inspection end time, the start point temperature T0 (20.0° C. in the embodiment) at the time of the easy inspection, and the time (required time m) required to drop the temperature by the reference drop temperature t=3° C. in the storage part 82 of the control device 8. In addition, the microcontroller unit 81 switches the temperature control of the rotation chamber 4 to the control aiming at the set temperature 109 (see FIG. 2) (Step 56). Then, when the user presses the RUN SCREEN button 159b (see FIG. 7) in the screen of FIG. 7 (Step 57), the flow returns to the display screen 100, and the operation of the cooling system easy inspection mode ends.

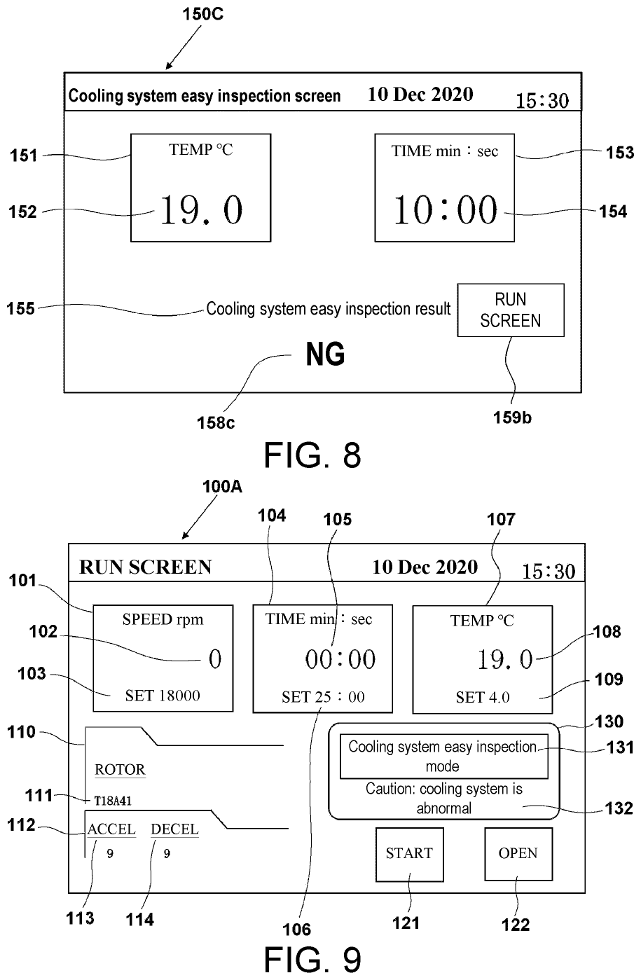

In the case where, in Step 54, the temperature of the rotation chamber 4 does not reach the prescribed temperature (=17.0° C.) lower than the start point temperature T₀=20° C. by the reference drop temperature t=3° C. within the reference time M (10 minutes), the microcontroller unit 81 determines that the performance of the cooling system 9 deteriorates for some reason, and displays on the display panel 10 “NG (=No Good)” as the easy inspection result (Step 58). Such display content is displayed in a display screen 150C of FIG. 8.

The display screen 150C of FIG. 8 is a screen indicating that the easy inspection is completed and not passed, and is a transition screen from the display screen 150A of FIG. 6 in place of FIG. 7. The upper half region of the display screen 150C has the same contents as FIG. 6, and it is displayed that the current temperature 152 of the rotation chamber 4 measured by the temperature sensor 12 is 19.0° C., which drops from the start point temperature T₀=20° C. shown in FIG. 3 by 1° C. In addition, in the inspection time display field 153, “10:00” is displayed as the elapsed time 154. As a result, it is shown that, although the cooling system has been operating and 10 minutes have passed, the temperature drop of the reference drop temperature t=3° C. cannot be achieved during the time period. The elapsed time 154 stops counting up when the reference time M (=10 minutes) has passed, and the display of “10:00” is maintained.

The message 155 to the user displays the information indicating the easy inspection ends and showing the result. That is, the message 155 displays “cooling system easy inspection result”, and displays, on the lower side thereof, contents corresponding to the message 155, indicating “NG” here, as an easy inspection result 158a. At this time, it may also be that information about possible causes of NG (e.g., “Refrigerant is possibly insufficient”) is displayed together, in addition to displaying “NG”. The display screen 150C in FIG. 8 continues to be displayed until the user confirms the contents thereof and presses the RUN SCREEN button 159b for returning to the display screen 100 of FIG. 2. In the case where the easy inspection result 158c is “NG”, a limitation may be imposed on the subsequent centrifugal operation. Such limitation may be, for example, setting a lower limit on the temperature setting of the rotation chamber 4, or limiting the number of times of operation (e.g., no more than three times) or the operation time (e.g. no more than 1 hour) permitted after the determination that there is an abnormality. In addition, it may also be configured that the centrifugal separation operation is completely prohibited in the case where the easy inspection result 158C is “NG”. In the case where the centrifugal separation operation is completely prohibited, an alert display indicating that the operation is prohibited and a message (not shown) to the user indicating “Please call the support center of the manufacturer” may be displayed.

Referring to FIG. 5 again, in Step 58, the display screen 150C indicating “cooling system is abnormal” is displayed, and the microcontroller unit 81 stores the information of the execution date of the easy inspection, the inspection end time, the start point temperature T₀ (20.0° C. in the embodiment) at the time of the easy inspection, and “10 minutes and 00 seconds” as the required time m in the storage part 82 of the control device 8. In addition, the microcontroller unit 81 switches the temperature control of the rotation chamber 4 to the control aiming at the set temperature 109 (see FIG. 2) (Step 58). The switching to the control aiming at the set temperature 109 (see FIG. 2) when the cooling system is abnormal (more specifically, deteriorates) is for the user to determine whether to execute the centrifugal separation operation even in the deteriorated state. When the user presses RUN SCREEN button 159b (see FIG. 8) on the screen of FIG. 7 (Step 59), the microcontroller unit 81 ends the easy inspection and returns to a display screen 100A of FIG. 9.

FIG. 9 is a view illustrating the display screen 100A after the cooling system easy inspection of the invention is executed. Although FIG. 9 is basically the same as the display screen 100 shown in FIG. 2 before the cooling system easy inspection is executed, since FIG. 9 illustrates a screen after the cooling system easy inspection is executed and the screen is transitioned from the screen shown in FIG. 8, the rotor temperature 108 becomes 19.0° C. In addition, the display contents of the associated information 132 of the cooling system easy inspection mode field 130 are changed. This is because the easy inspection result 158c shown in FIG. 8 indicates “NG”, and therefore “Caution: cooling system is abnormal” is displayed in the associated information 132 to inform the user. At this time, the fact that the cooling system is abnormal is displayed to the user by using a display mode different from normal display, such as coloring, highlighting, inversion, blinking, etc., in the cooling system easy inspection mode field 130. In the embodiment, if the abnormality of the cooling system is slight, the start button 121 may be displayed in FIG. 9 and the centrifugal separation operation immediately afterwards may be performed several times. However, if the abnormality of the cooling system is critical, the microcontroller unit 81 may prevent the centrifugal separation operation from starting by displaying the start button 121 in gray and may not respond even touched by the user.

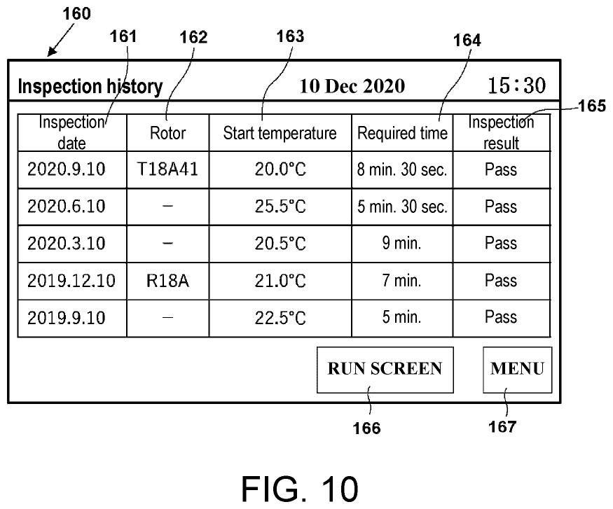

FIG. 10 illustrates a display screen 160 illustrating history contents of an easy inspection stored in the storage part 82 in Steps 56, 58 of FIG. 5. In the embodiment, when the cooling system easy inspection is executed, an inspection date 161 thereof, a temperature 163 (start point temperature t₀) when the inspection starts, a required time 164, and other data are stored in the storage part 82. With the storage part 82 using a non-volatile memory device, the microcontroller unit 81 can retrieve and display record data on the operation panel 10 when the power of the centrifuge 1 is ON (or when it is possible to execute the easy inspection). In the display screen 160, “inspection history”, which is the title of the screen is displayed at the upper part, and the current date and time are displayed on the right side thereof.

In a table that is displayed, a portion or all of the information stored in the storage part 82 is displayed in the format of a table. Here, the inspection date 161, the temperature 163 (start point temperature to) at the time of starting, the time (the required time 164) required for lowering the temperature by the reference drop temperature t(° C.), and an inspection result 165 are displayed. In the embodiment, the identification information (rotor 162) of the rotor 5 (see FIG. 1) is further included as additional information. In the case where the rotor 5 (see FIG. 1) is installed inside the rotation chamber 4 when the easy inspection is executed, the type number of the rotor 5 is also stored in the storage part 82 and displayed in the field of the rotor 162 in the display screen 160 of FIG. 10. “-” in the field of the rotor 162 indicates that the easy inspection mode is executed in the state in which the rotor 5 (see FIG. 1) is not installed.

Although FIG. 10 illustrates five entries of the inspection history, it may also be configured so that more cases can be displayed by using scrollable display on the screen. Also, FIG. 10 includes the inspection result 165 in one of the display items of the display screen 160 and respectively displays “Pass” or NG″. However, it may also be configured that the field of the inspection result 165 is not provided, and, in the required time, a passed field is displayed normally, and an NG field is displayed in a red background or white text, so that the user can indirectly recognize the inspection result (“Pass” or “NG”) through the display mode of the number of the inspection result 165.

On the lower right of the display screen 160, two buttons in the form of icons for the transition to the next screen are displayed. One of the buttons is a RUN SCREEN button 166 for returning to the display screen 100 shown in FIG. 2, and the other is a MENU button 167 for transitioning to a menu screen for performing various settings, etc.

In addition to the above example, the embodiment can be modified in various ways. For example, in Steps 42 to 44 of FIG. 4, it is configured that the door 7 is closed and then the operation button (start button) 131 is firstly displayed, and the operation button 131 is pressed (touched) to start the execution of the cooling system easy inspection. However, in other embodiments, it may also be configured that, even in the state in which the door 7 is opened, the cooling system easy inspection mode field 130 and the operation button 131 are displayed on the display screen 100, and the user can touch the operation button 131 before the door 7 is closed. In such case, it may be configured that the execution of the cooling system easy inspection is started at a time point after the touch button 156 of FIG. 4 is pressed and when the door 7 is closed.

The start point temperature T₀, the reference drop temperature t, the reference time M for the easy inspection can be set variously in accordance with the inspection items as required. For example, it may also be configured that the start point temperature T₀ is not set as the temperature of the rotation chamber 4 or the bowl 3 detected by the temperature sensor 12 immediately after the compressor 9a is operated as in the above embodiment, but is set to a fixed temperature (e.g., T₀=8° C.), and the time required for the temperature of the rotation chamber 4 or the bowl 3 to further drop by the temperature t after reaching T₀ is measured, that is, the time required for the temperature to drop from the temperature T₀ to the temperature T₀−t is measured. In addition, it may also be that the microcontroller unit 81 measures an outside air temperature (room temperature), and sets the start point temperature T₀, or the reference drop temperature (prescribed temperature) t, the reference time M taking into consideration the relative relationship with the room temperature. The set range of the reference drop temperature t is arbitrary, and may be as high as 5° C. or as low as 2° C.

According to the embodiment, a centrifuge is provided. The centrifuge is provided with a function of being able to easily perform easy inspection in addition to the function of notifying the user, so as to be able to periodically executing easy inspection of the cooling system. Therefore, compared with the conventional centrifuge, the reliability of the cooling system can be facilitated, and the inspection standards based on laws, standards, etc., are easily satisfied.

Although the invention has been described above based on the embodiments, the invention is not limited to the above-described embodiments, and various modifications can be made without departing from the scope of the invention. For example, as the centrifuge, the same applies to a centrifuge equipped with a vacuum pump in addition to the cooling system. In such case, the cooling system easy inspection mode can be executed in the same procedures as the above embodiments as long as the vacuum pump is stopped when the cooling system easy inspection is executed.

Also, in the embodiment, the microcontroller unit 18 measures the time until the temperature drops to the predetermined temperature to determine whether the cooling system is abnormal. However, as other methods, it may also be configured that the microcontroller unit 81 determines whether the cooling system is abnormal by comparing the slope (gradient) of the temperature change calculated from measured values with a reference temperature change slope stored in advance.

### REFERENCE SIGNS LIST

1: Centrifuge; 2: Housing; 3: Bowl; 4: Rotation chamber; 4a: Opening part; 4b: Through hole; 5: Rotor; 5a: Cover (of the rotor); 6: Driving device (motor); 6: Rotation shaft (of the driving device); 7: Door; 8: Control device; 9: Cooling system; 9a: Compressor; 9b: Condenser; 9c to 9e: Copper pipe; 10: Operation panel; 11: Door opening/closing detection sensor; 12: Temperature sensor; 81: Microcontroller unit; 82: Storage part; 100, 100A: Display screen; 101: Rotor rotation speed display field; 102: Rotation speed; 103: Set rotation speed; 104: Rotation time display field; 105: Elapsed time; 106: Set time; 107: Rotor temperature display field; 108: Rotor temperature; 109: Set temperature; 110: Rotor name display field; 111: Rotor name; 112: Deceleration mode display region; 113: Acceleration gradient; 114: Deceleration gradient; 121: Start button; 122: Open button; 130: Cooling system easy inspection mode field; 131: Operation button; 132: Associated information; 150, 150A, 150B, 150C: Display screen; 151: Current temperature display field; 152: Current temperature; 153: Inspection time display field; 154: Elapsed time; 155: message; 156: Execution button; 157: Cancel button; 158a: Status information; 159a: Stop button; 159b: RUN SCREEN button; 160: Display screen; 161: Inspection date; 162: Rotor; 163: Temperature when inspection starts; 164: Required time; 165: Inspection result; 166: RUN SCREEN button; 167: Menu button; M: Reference time; m: Required time; To: Start point temperature; t: Reference drop temperature.

1. A centrifuge, comprising:
a driving device;
a bowl, accommodating a rotor rotating by using the driving device;
a sensor, detecting a temperature inside the bowl;
a cooling device for cooling an interior of the bowl;
a display part, inputting a centrifugal separation operation condition and displaying an operation state; and
a control part, controlling the display part,
wherein the centrifuge is provided with an easy inspection mode for detecting an abnormality of the cooling device, and
when the easy inspection mode is selected, the control part determines whether the cooling device is abnormal while operating a compressor provided in the cooling device at a speed determined in advance.

2. The centrifuge as claimed in claim 1, wherein when the easy inspection mode is selected, the control part:
determines whether the cooling device is abnormal based on whether a temperature drops from a predetermined temperature to a prescribed temperature within a predetermined time period, and
displays a determination result on the display part.

3. The centrifuge as claimed in claim 2, wherein when the easy inspection mode is selected, the control part:
measures a required time from the predetermined temperature to the prescribed temperature,
determines whether the cooling device is abnormal from the required time, and
displays the determination result on the display part.

4. The centrifuge as claimed in claim 3, wherein the required time and a temperature reached within the predetermined time period are stored, together with date data, in a non-volatile storage part.

5. The centrifuge as claimed in claim 4, wherein, based on the date data stored in the storage part, a next inspection execution date is calculated and displayed on the display part.

6. The centrifuge as claimed in claim 1, wherein the easy inspection mode is executed in a state in which the rotor is not installed or in a state in which the rotor that is installed is not rotated.

7. The centrifuge as claimed in claim 5, wherein when power of the centrifuge is activated, the control part compares a current date and time with the next inspection execution date, and
if a number of days until the next inspection execution date is less than a predetermined number of days, an alert is displayed on the display part.

8. The centrifuge as claimed in claim 4, wherein the control part displays an overview of execution results of inspection modes stored in the storage part on the display part.

9. The centrifuge as claimed in claim 1, wherein in a case of determining the cooling device as abnormal according to an execution result of the easy inspection mode, the control part prohibits or limits an operation of the centrifuge.
